(19) United States
(12) Patent Application Publication
(10) Pub. No.: US 2009/0238626 A1
(43) Pub. Date: Sep. 24, 2009

(54) CREATION AND PLACEMENT OF TWO-DIMENSIONAL BARCODE STAMPS ON PRINTED DOCUMENTS FOR STORING AUTHENTICATION INFORMATION

(75) Inventors: Wei Ming, Cupertino, CA (US); Maria Qian Zhao, San Pablo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/050,718

(22) Filed: Mar. 18, 2008

(51) Int. Cl. B41J 11/44

(52) U.S. Cl. 400/76

(57) ABSTRACT

A document authenticating method is disclosed by which numerous small-sized two-dimensional barcode stamps are generated and placed in a distributed manner on a printed document. The small-sized barcode stamps collectively encode the content of the document to be used for document authentication. In one example, the stamp size is 1 cm by 1 cm and the tile size for the stamps is 4 by 4 pixels at a resolution of 400 dpi. A total of approximately 80 such small barcode stamps are placed on the page to form a pattern that resembles a border on one or more sides of the page. In one particular example, the stamps are placed on all four sides of the page to form a frame. Such a stamp layout minimizes undesirable visual effect and can create a decorative effect. Small-sized stamps also allow reduced tile sizes and increased information density.

### CROSS REFERENCE TO RELATED APPLICATIONS

This application cross-references and incorporates by reference U.S. patent application Ser. No. ______, filed ______, entitled “Creation and placement of two-dimensional barcode stamps on printed documents for storing authentication information” (Attorney Docket No. 75675.B179).

### BACKGROUND OF THE INVENTION

1. Field of the Invention

This invention relates to the application of two-dimensional barcode in document authentication, and in particular, it relates to the creation and placement of barcode stamps on printed documents.

2. Description of Related Art

Barcode is a form of machine-readable symbology for encoding data, and has been widely introduced in a variety of application fields. Two-dimensional barcode (2d barcode) is one mode of such symbology, and can be used to encode text, numbers, images, and binary data streams in general, and has been used in identification cards, shipping labels, certificates and other documents, etc. Examples of widely used 2d barcode standards include PDF417 standard and QR Code®, and software and hardware products have been available to print and read such 2d barcodes.

Original digital documents, which may include text, graphics, images, etc., are often printed, and the printed hard copy are distributed, copied, etc., and then often scanned back into digital form. This is referred to a closed-loop process. Authenticating a scanned digital document refers to determining whether the scanned document is an authentic copy of the original digital document, i.e., whether the document has been altered while it was in the hard copy form. Alteration may occur due to deliberate effort or accidental events. Methods have been proposed to authenticate a printed document using 2d barcode. Specifically, the method includes encoding the content of the document in a 2d barcode (the authentication barcode), and printing the barcode on the same recording medium as the printed document. The content of the document may be a bitmap image of a page of the document, text or graphics contained within the document, or a mixture thereof. To authenticate a printed document bearing an authentication barcode, the document is scanned to obtain scanned data that represents the content of the document, e.g. a bitmap image, or text extracted by using an optical character recognition (OCR) technology. The authentication barcode is also scanned and the data contained therein (the authentication data) is extracted. The scanned data is then compared to the authentication data to determine if any part of the printed document has been altered since it was originally printed, i.e. whether the document is authentic. Some authentication technologies are able to determine the authentication content, some merely determines whether any alterations have occurred. A printed document bearing authentication barcode is said to be self-authenticating because no information other than what is on the printed document is required to authenticate its content.

### SUMMARY

The present invention is directed to a method and related apparatus for encoding document authentication data in two-dimensional barcode stamps and placing the barcode stamps in a distributed manner across the page.

An object of the present invention is to efficiently utilize the space of a page to place barcode stamps.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for printing a document, which includes: obtaining document content for the document; obtaining metadata to be encoded in barcode stamps; generating a plurality of two-dimensional barcode stamps encoding the metadata, each barcode stamp having a predetermined stamp size, the plurality of barcode stamps being distributed along and extending substantially an entire length of at least one side of a page of the document; and printing the document content and the plurality of barcode stamps on a recording medium.

In another aspect, the present invention provides a method for printing a document, which includes: obtaining document content for the document; obtaining authentication data to be encoded in barcode stamps; generating a plurality of two-dimensional barcode stamps encoding the authentication data, each barcode stamp having a stamp size of approximately 1 cm by 1 cm, the plurality of barcode stamps being distributed across a page of the document; and printing the document content and the plurality of barcode stamps on a recording medium.

In another aspect, the present invention provides a computer program product that controls a data processing apparatus to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIGS. 1A and 1B schematically illustrate a printed document bearing 2d barcode stamps for document authentication according to embodiments of the present invention.

FIG. 2 illustrates a process of generating a printed document bearing 2d barcode stamps for document authentication.

FIG. 3 illustrates a process for scanning a printed document bearing 2d barcode stamps and authenticating the document.

### DETAILED DESCRIPTION OF PREFERRED EMBODIMENTS

To generate a self-authenticating document using 2d barcodes, a relatively large amount of data representing the content of the document must be encoded in the barcodes. The content of the document may include bitmap images, graphics, and text. The text may originate from the application that created the document, or extracted from images using optical character recognition (OCR) techniques. Existing methods of authenticating documents have used 2d barcodes having relatively large stamp sizes, such as 2 inches by 2 inches. Typical tile size recoverable after the closed-loop process span no less than 6 by 6 pixels (dots) at a resolution of 400 dpi. Here, barcode stamps refer to individual blocks each having well defined boundaries and constituting a barcode; tiles refer to the small black or white (or color) elements arranged in a defined pattern that collectively comprise a barcode stamp. Multiple barcode stamps are typically needed to encode the content of a page of document. For example, using 2 inches by 2 inches stamps at the above tile size, more than ten stamps may be required to encode the content of one typical page of document. Such stamps must be placed in a white area of the document where no document image exists. In most instances, there is insufficient white area on the document to print the stamps. It has been proposed to print the stamps on the backside of the document.

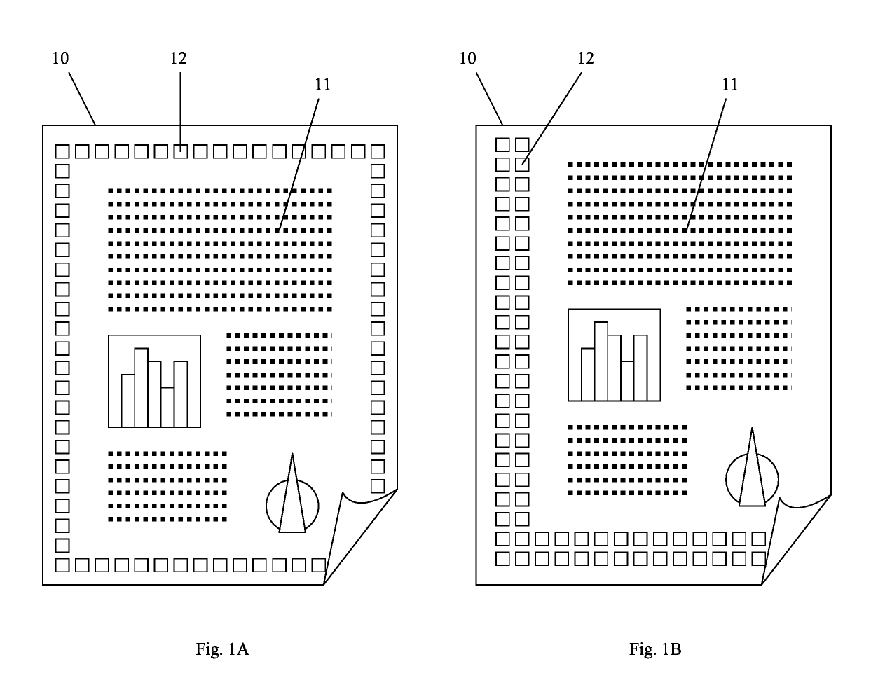

Embodiments of the present invention provide a document authentication method by which numerous small-sized 2d barcode stamps are generated and placed in a distributed manner on the printed document. In one particular example, the stamp size is 1 cm by 1 cm and the tile size for the stamps is 4 by 4 pixels at a resolution of 400 dpi. Each such stamp contains approximately 100 bytes of information. A total of approximately 80 such small barcode stamps, which collectively encode the content of the document, are placed on the page to form a pattern that resembles a border on one or more sides of the page. The content of the document encoded in the barcode stamps include text extracted by OCR techniques (or other forms of character recognition techniques) as well as graphics and images. FIGS. 1A and 1B schematically illustrate examples of such a page. The page of document 10 contains document content 11, which in this example includes text and graphics, and a plurality of 2d barcode stamps 12. In the example of FIG. 1A, the stamps 12 are placed on all four sides of the page, forming a frame. In the example of FIG. 1B, the stamps 12 form a border on the left and bottom sides, and two columns or rows of stamps are placed on each side. In both examples, the barcode stamps 12 extend substantially the entire length of the one or more sides of the page. These are merely examples; other ways of distributing the stamps on the page may be employed. Other stamp sizes and tile sizes may be used as well.

By using smaller stamp sizes, the tile size for the barcode stamps can be reduced. This is because the lower limit of the tile size is typically determined by distortions introduced in the printing and scanning process, such s skew. Reducing the barcode stamp size reduces the total amount of distortion across each stamp. As a result, the tile size can be reduced and information density increased. In the above examples, reducing the stamp size to 1 cm by 1 cm allows the tile size to be reduced to 4 by 4 pixels from 6 by 6 pixels. A number of small barcode stamps combined generally have larger data storage capacity than a single large barcode stamp that encompasses the same physical size as the combined small barcode stamps.

In addition, small barcode stamps offer flexibility in stamp placement. By distributing the small-sized stamps in a layout pattern shown in FIGS. 1A and 1B, or other suitable layout patterns, the white space in the document such as the page margin can be efficiently utilized. As a result, no or minimal (e.g. less than 20%) size reduction of the document image can be achieved. The distributed layout of small-sized barcode stamps also minimizes undesirable visual effect, and can in fact be used to create a decorative visual effect.

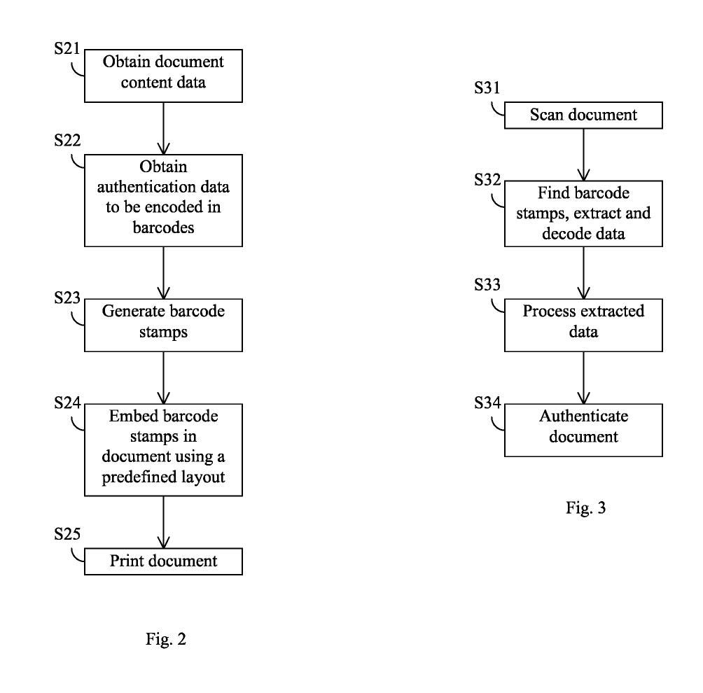

The method of generating 2d barcode stamps for document authentication is generally known to those skilled in the relevant art. The method is typically implemented by software in a computer, printer or other data processing apparatus. As shown in FIG. 2, the process first obtains the document content data (step S21). The data may originate from an application program such as a word processing application, a PDF writer application, etc., or from scanning a hard copy of a document. The document content data may be in any appropriate format, such as text, bitmap image, etc. The process then obtains authentication data to be encoded in barcodes (step S22). This step may entail processing the document content data to obtain the authentication data, such as compressing the document content data, digitally signing the data (optional), and encrypting the data (optional). Compression is optional but is generally desired to reduce data size. Other processing may also be performed on the document content data, such as extracting text data from image data using OCR techniques, down sampling image data to reduce its size, etc. Alternatively or in addition, step S22 may include obtaining the data to be encoded in barcodes from an independent source, such as the application that created the document. The authentication data is then encoded to generate a plurality of barcode stamps having a predetermined size (step S23). Each barcode stamp preferably contains sequence information so that the data encoded in the plurality of stamps can be properly assembled during decoding. The barcode stamps are embedded in the document using a predetermined layout such as those described earlier (step S24), and the document bearing the barcode stamps is printed (step S25).

In the authenticating process, shown in FIG. 3, the document is scanned (step S31), and the barcode stamps are identified and the data encoded therein is extracted and decoded (step S32). The data is processed (step S33), including decryption (optional), digital signature verification (optional), decompression, etc. The processed data is used to authenticate the document (step S34). The process of authenticating a document using extracted data is generally known to those skilled in the relevant art and a more detailed description is omitted here.

Although embodiments of the present invention are described above in the context of document authentication, the invention may be used when barcodes are printed on a page of document for other purposes. For example, a page may bear barcode stamps that store metadata about the document, such as filename, author, title, subject, category, keywords, comments, revision number, etc. The data to be encoded in barcodes may be generally referred to as metadata in this disclosure. The invention is especially advantageous when the amount of metadata (such as authentication data) to be encoded in the barcode stamps is large.

It will be apparent to those skilled in the art that various modification and variations can be made in the barcode creation and placement method of the present invention without departing from the spirit or scope of the invention. Thus, it is intended that the present invention cover modifications and variations that come within the scope of the appended claims and their equivalents.

What is claimed is:

1. A method for printing a document, comprising:
obtaining a content of the document;
obtaining metadata to be encoded in barcode stamps;
generating a plurality of two-dimensional barcode stamps encoding the metadata, each barcode stamp having a predetermined stamp size, the plurality of barcode stamps being distributed along and extending substantially an entire length of at least one side of a page of the document; and
printing the content of the document and the plurality of barcode stamps on a recording medium.

2. The method of claim 1, wherein the stamp size is 1 cm by 1 cm.

3. The method of claim 1, wherein a tile size of each barcode stamp is 4 by 4 pixels at a resolution of 400 dots per inch.

4. The method of claim 1, wherein the plurality of barcode stamps are distributed along all four sides of the page of the document forming a frame of the page.

5. The method of claim 1, wherein the plurality of barcode stamps are distributed along a left and a bottom side of the page of the document.

6. The method of claim 1, wherein the content of the document is printed with less than 20% size reduction.

7. The method of claim 1, wherein the metadata includes authentication data.

8. The method of claim 1, further comprising:
scanning the printed document having the plurality of barcode stamps; and
extracting and decoding the metadata encoded in the plurality of barcode stamps.

9. The method of claim 8, wherein the metadata includes authentication data, the method further comprising authenticating the scanned document using the authentication data.

10. A method for printing a document, comprising:
obtaining a content of the document;
obtaining authentication data;
generating a plurality of two-dimensional barcode stamps encoding the authentication data, each barcode stamp having a stamp size of approximately 1 cm by 1 cm, the plurality of barcode stamps being distributed across a page of the document; and
printing the content of the document and the plurality of barcode stamps on a recording medium.

11. The method of claim 10, wherein a tile size of each barcode stamp is 4 by 4 pixels at a resolution of 400 dots per inch.

12. The method of claim 10, wherein the content of the document is printed with less than 20% size reduction.

13. The method of claim 10, further comprising:
scanning the printed document having the plurality of barcode stamps;
extracting and decoding the authentication data encoded in the plurality of barcode stamps; and
authenticating the scanned document using the authentication data.

14. A computer program product comprising a computer usable medium having a computer readable code embodied therein for controlling a data processing apparatus, the computer readable program code configured to cause the data processing apparatus to execute a process for printing a document comprising the steps of:
obtaining a content of the document;
obtaining metadata to be encoded in barcode stamps;
generating a plurality of two-dimensional barcode stamps encoding the metadata, each barcode stamp having a predetermined stamp size, the plurality of barcode stamps being distributed along and extending substantially an entire length of at least one side of a page of the document; and
printing the content of the document and the plurality of barcode stamps on a recording medium.

15. The computer program product of claim 14, wherein the metadata includes authentication data, and wherein the process further comprises:
scanning the printed document having the plurality of barcode stamps;
extracting and decoding the authentication data from the plurality of barcode stamps; and
authenticating the scanned document using the authentication data.

16. A computer program product comprising a computer usable medium having a computer readable code embodied therein for controlling a data processing apparatus, the computer readable program code configured to cause the data processing apparatus to execute a process for printing a document comprising the steps of:
obtaining a content of the document;
obtaining authentication data;
generating a plurality of two-dimensional barcode stamps encoding the authentication data, each barcode stamp having a stamp size of approximately 1 cm by 1 cm, the plurality of barcode stamps being distributed across a page of the document; and
printing the content of the document and the plurality of barcode stamps on a recording medium.

17. The computer program product of claim 16, wherein the process further comprises:
scanning the printed document having the plurality of barcode stamps;
extracting and decoding the authentication data from the plurality of barcode stamps; and
authenticating the scanned document using the authentication data.
